(19) United States
(12) Patent Application Publication
(10) Pub. No.: US 2026/0185937 A1
(43) Pub. Date: Jul. 2, 2026

(54) Method

(71) Applicant: HYDAC Filter Systems GmbH, Sulzbach / Saar (DE)

(72) Inventors: Jörg Steffensky, Dillingen (DE); Torsten Bley, Beckingen (DE); Philipp Götz, Eppelborn (DE)

(73) Assignee: HYDAC Filter Systems GmbH, Sulzbach / Saar (DE)

(21) Appl. No.: 18/864,248

(22) PCT Filed: Apr. 24, 2023
(86) PCT No.: PCT/EP2023/060681

§ 371 Date: Feb. 20, 2025

(30) Foreign Application Priority Data
May 9, 2022 (DE) 10 2022 111 448.1

(51) Int. Cl. G01N 21/41; G01N 21/93; G01N 21/94

(52) U.S. Cl. CPC G01N 21/4133; G01N 21/93; G01N 21/94; G01N 2201/0612; G01N 2201/0692

(57) ABSTRACT

Disclosed is method for determining the concentration of constituents in a fluid, such as cutting fluids or HFC fluids, using refractometry by means of a laser of a measuring device that uses the transmitted light principle, comprises specifying a peak value for the laser light received by refraction on a photodiode line using a homogeneous fluid to be transilluminated, and keeping the peak value constant despite the occurrence of disturbances by adapting one or more of the duty cycle of the laser, the current intensity for the laser, and the sensitivity of the photodiode line.

### CROSS-REFERENCE TO RELATED APPLICATIONS

This application claims priority to German Patent Application DE 10 2022 111 448.1, filed on May 9, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for determining the concentration of constituents in a fluid, such as cooling lubricants or HFC fluids by using refractometry.

DE 10 2010 028 319 A1 discloses a method for controlling the concentration of water-mixed cooling lubricant in a machine tool and an associated apparatus, which serve both to measure the index of refraction of the water-mixed cooling lubricant by refractometry and to measure the electrical conductivity of the water-mixed cooling lubricant, and to combine the values obtained from both measurements to give a control variable with which a top-up with water and/or cooling lubricant takes place if the control variable deviates from the target value. To determine the index of refraction of the water-mixed cooling lubricant, a digital refractometer is used in the apparatus, comprising an LED as the light source and a CCD sensor as the detector.

### SUMMARY

A need exists to provide an improved measurement method with which one or more disturbance variables potentially arising during the measurement can be compensated.

The need is addressed by the subject matter of the independent claim(s). Embodiments of the invention are described in the dependent claims, the following description, and the drawings.

### BRIEF DESCRIPTION OF THE DRAWINGS

FIG. 1 takes the form of a longitudinal section showing components of an example measuring apparatus;

FIGS. 2 to 5 show different options for carrying out measurements using the transmitted light principle;

FIGS. 6, 7, 8 and 10 show different types of operation of an example measuring apparatus using flowcharts; and

FIG. 9 takes the form of a hydraulic circuit diagram showing how an example measuring apparatus is incorporated in an £ example hydraulic measurement and supply circuit.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments use a laser of a measuring apparatus for refractometry, said measuring apparatus operating with the transmitted light principle by carrying out at least the following method steps:
specifying a peak value for the laser light received by refraction on a diode array using a homogeneous fluid to be transilluminated, and
keeping the peak value constant despite the occurrence of disturbances by adapting
the duty cycle of the laser and/or
the current intensity for the laser and/or
the sensitivity of the diode array using an evaluation device.

In this manner, even if various disturbance variables arise during the measurement, a reliable concentration determination can be achieved in fluids, wherein the laser used permits collimation, i.e., a parallel alignment of otherwise divergent light beams, which leads to an improved measured value resolution on the part of the sensor device, which is usually formed by a photodiode array or diode array.

In some embodiments, such a disturbance may be formed by cloudiness of the fluid, which leads to a loss of intensity of the peak value of the laser light received on the diode array. A further potential disturbance variable is formed by a finely dispersed particulate contamination, as a result of which a wide-ranging increase in intensity arises due to laser scattering on the diode array. Further disruption variables are formed by larger particles or air bubbles which are entrained in the fluid to be measured along with said fluid and lead to the short-term occurrence of measured value peaks on the diode array, the measured value thereof being smaller than the peak value measured during refraction by a homogeneous fluid.

A further disruption variable is formed by contamination on a laser-translucent wall of the sample chamber with which the method is performed and along which the fluid is passed, through both of which the laser light is passed, wherein the contamination is detected by the diode array by a path displacement with respect to the set peak value during the usual refraction process.

Independently of the disturbance variable that arises in each case, this can be reliably detected by the measured value method and compensated by carrying out the method as described at the outset.

In some embodiments of the method, it is provided that, for a measurement operation with the measuring apparatus, said apparatus is calibrated using a reference fluid to a pre-definable value of the index of refraction. In this process, a reference fluid such as water with a known refraction index behaviour is for example used for the calibration.

In some embodiments of the method, it is provided that, during a flushing operation of the measuring apparatus, flushing of the sample chamber takes place with the reference fluid, f that a comparison takes place between the actual value and the target value of the respective index of refraction, and that a potential deviation is taken into consideration in the calibration and an error message is output if the deviation is excessive. In this manner, calibration is able to take place together with a flushing operation of the measuring apparatus.

In some embodiments of the method, it is provided that the measuring apparatus is monitored by the higher-level evaluation device, which for example performs open-loop and/or closed-loop control tasks in addition to recording measured values, and which evaluates measurement data from additional, externally connected measurement devices, such as temperature, pressure, viscosity, electrical conductivity, pH value, etc., and that, as a function of the measurement data received, external actuators are actuated, such as hydraulic pumps, valves, level switches, etc. In this manner, a substantially automated measurement method operation is possible and a wide range of additional monitoring tasks can be incorporated in the control system for machining equipment as the load.

For example, for this purpose, it is provided that the measuring apparatus is connected in a secondary branch of a hydraulic supply circuit which supplies a hydraulic load with fluid, said measuring apparatus being connected to or disconnected from the supply circuit by means of a valve controller. In this manner, the actual measurement method with the respective measuring apparatus can be disconnected from the fluid supply for a load connected to the supply circuit, which helps makes it easier to perform maintenance operations.

In particular, the method according to the teachings herein is beneficially characterised in that the fluid is admitted to the fluidic supply circuit by a supply device, monitored by a measuring apparatus, if there is insufficient concentrate in the fluid.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

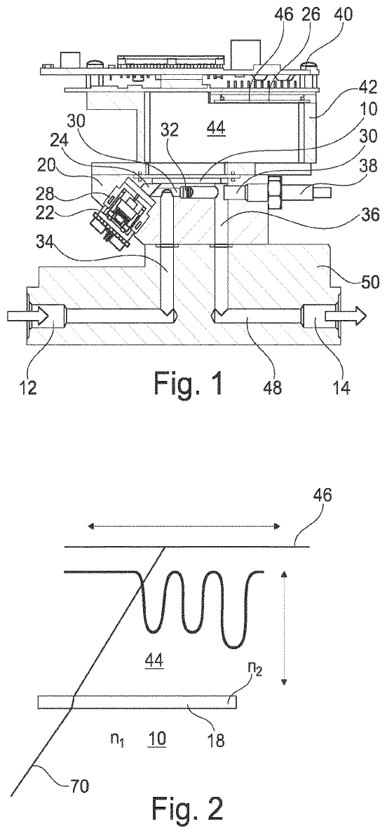

The measuring apparatus shown in FIG. 1 with its system components is shown in the usual operating position. The measuring apparatus serves to determine the concentration of constituents in a fluid, such as cooling lubricants or HFC hydraulic fluids, by refractometry. Hydraulic fluid is generally used to transmit energy in the form of volume flow and/or pressure in hydraulic systems in the field of fluid technology. Corresponding hydraulic oils are usually manufactured based on mineral oil with corresponding additives. HFC is a fire-resistant hydraulic fluid and generally comprises water glycols with a water content in excess of 35% and a polyglycol solution. Corresponding HFC hydraulic fluids are regularly provided for use in coal mining and in the civil aviation industry. Furthermore, these are increasingly used in military vehicles such as tanks, which may be exposed to enemy fire. Cooling lubricants or cooling lubricant materials reduce friction due to lubrication and thus reduce wear on the tool, overheating of the tool and the energy required during cutting-type machining operations. In both cases, the proposed concentration of HFC and cooling lubricant should be maintained in order to guarantee reliable operation. As such, the measuring apparatus according to the teachings herein is used to maintain the respective concentration.

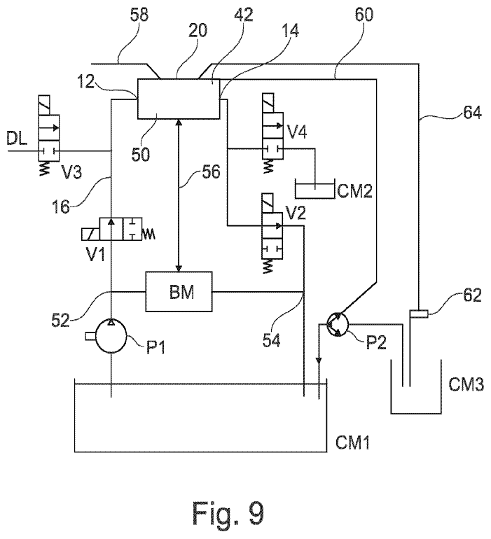

The fluid provided for measurement purposes by means of the measuring apparatus is guided through a sample chamber 10 which is connected to a fluid inlet 12 and a fluid outlet 14. In this case, the possible throughflow direction is shown in FIG. 1 with arrows at the inlet 12 and at the outlet 14. Both the fluid inlet 12 and the fluid outlet 14 are connected in the usual manner to a fluid supply circuit 16, as reproduced in FIG. 9 by way of example.

The actual sample chamber 10 delimits a cuboid chamber volume with a flat extension and, in the viewing direction seen on FIG. 1, is delimited from the top by a translucent glass wall 18; usually formed by a thin-walled rectangular glass pane, which is delimited towards the top and bottom on its outer circumference from adjacent housing parts of the measuring apparatus by square sealing rings so as to thus reliably avoid undesirable leakage of fluid from the sample chamber 10 into the environment. Abutting the side of the sample chamber 10, a laser 22 is fitted in an apparatus housing 20 of the measuring apparatus, the upper discharge surface of said laser emerging in a fluid-conveying oblique channel 24 in the direction of the sample chamber 10. In this manner, the beams from a light source, in this case in the form of the laser 22, pass through the sample chamber 10 containing the respective fluid and the corresponding beams thus experience a first refraction n, which will be explained in more detail below. The beams refracted in this manner are detected by a sensor device 26 outside the sample chamber 10. The sensor device 26 comprises a photodiode array, which is also referred to in technical jargon as a diode array, as a light-sensitive sensor. In particular, CCD sensors, but also CMOS sensors, are used in this respect, which, as light-sensitive electronic components, are based on the internal photo effect and are commercially available on the market in a range of embodiments.

As is also shown on FIG. 1, the light source in the form of the laser 22 is received in a stationary manner in an assigned receiving chamber 28 at one end of the apparatus housing 20 such that, before the fluid enters the actual sample chamber 10, the fluid flows over the discharge cross-section for the laser beams, in which said fluid flows from a horizontally extending pipe portion 30 parallel to the longitudinal orientation of the sample chamber 10 into the oblique channel 24. In the viewing direction seen on FIG. 1, the pipe portion 30 is sealed on its right-hand side by a plug 32, and otherwise pipe portions 34 and 36, which run vertically from the bottom emerge into the corresponding horizontal pipe portion 30, which, in the viewing direction seen on FIG. 1, continues onwards towards the right behind the plug 32 and emerges into the vertical pipe portion 36, to which the fluid outlet 14 is connected. However, the fluid inlet 12 leads from the left into the vertical pipe portion 34 for the fluid supply to the sample chamber 10. Beyond the vertical pipe portion 36, the horizontal pipe portion 30 is guided further towards the right and is sealed by a sensor 38 at this point, said sensor possibly being formed, by way of example, by a measuring device for parameters such as pressure, temperature, viscosity, pH value, conductivity, etc. Sensors 38, which allow two or more different parameter measurements of this kind to take place, may also be used in this case. A temperature measurement: is required for temperature compensation for refractometry.

As is also shown in FIG. 1, the light from the light source in the form of the laser 22 is emitted at an oblique angle of approximately 40° to the horizontally running fluid flow direction into the sample chamber 10. The rectangular two-dimensional extension of the sensor device 26 is in any event selected, with regard to its position with respect to the light source, such that, both in the event of the transmitted light method and in the event of any glancing incidence of light beams at different angles, these are detected, for example over the full circumference, by the sensor device 26. For the purpose of calibrating the measuring apparatus and in particular for adjusting the sensor device 26 to the actual measurement conditions inside the measuring apparatus, said apparatus may be adjusted, as shown in the drawing in FIG. 2, both horizontally and vertically with respect to the light discharge point on the laser 22. To this end, it is sufficient to loosen and then re-tighten screws on an adjustment device 40 to which the sensor device 26 is fixed and by means of which said device can be positioned with respect to a sensor housing 42 arranged in a stationary manner. As such, the sensor housing 42, as part of the overall housing, abuts the upper side of the apparatus housing 20. In particular, the plate-shaped sensor device 26 emerges into a square sensor chamber 44 of the sensor housing 42, which can be furnished with a gas and in this manner fills a spatial distance between the sample chamber 10 with its translucent wall 18 and an exposed sensor surface 46 of the sensor device 26. For ease of illustration, in FIG. 1, both the laser 22 and the sensors in the form of the device 26 and the respective measurement device 38 are shown without any associated wiring. According to the respective wavelength and within which index of refraction the sensor device 26 is to be loaded, a working gas other than air can also be received in the sensor chamber 44, for example in the form of xenon. In a notional, vertical projection within the drawing plane of FIG. 1, the light source in the form of the laser 22 is arranged at the start of the sample chamber 10 and the beginning of the sensor device 26 is arranged at the end of the sample chamber 10. In this manner, this leads to measured values being detected particularly well in the entire region and, due to the oblique position of the laser 22, this leads to a good diffraction image or interference pattern during irradiation of the fluid in the sample chamber 10 and, furthermore, due to the oblique angle of incidence of the laser beams on the sensor surface 46, the installation space for the sensor housing 42 and thus for the measuring apparatus as a whole can be minimised, with the result that a corresponding measuring apparatus can be accommodated even in restricted installation conditions. This also makes it easier to retrofit existing systems with the measuring apparatus.

The channel portions 34, 36 running between the fluid inlet 12 and the fluid outlet 14 thus at least partially form a fluid channel 48 in a supply housing 50. Accordingly, the entire housing of the apparatus is composed of individual housing parts, consisting in particular of the supply housing 50 containing parts of the fluid channel 48, the apparatus housing 20 containing the light source, in this case in the form of the laser 22, and the sensor housing 42 containing the sensor device 26. This thus results in a modular structure for the entire housing of the measuring apparatus, which allows the measuring apparatus to be connected to a wide variety of machines and apparatus parts by adjusting individual components.

As already mentioned at the outset, the measuring apparatus is part of a fluid supply circuit 16 and this can be connected via a switchable valve V1 to a pressure supply device such as a hydraulic pump P1. The correspondingly motor-driven hydraulic pump P1 takes fluid, such as cooling lubricant or HFC fluid, from a storage tank CM1 and hydraulically supplies customary machining equipment BM as a load. The corresponding machining equipment BM is connected on its inlet side via a branch 52 to a fluid line between the hydraulic pump P1 and the switchable valve V1. The outlet side of the machining equipment BM in turn emerges, at a branch point 54, into a return line, which is connected to the fluid discharge in the form of the fluid outlet 14 in the supply housing 50 of the measuring apparatus and leads to the storage tank CM1. A further switching valve V2 is provided in the aforementioned portion of the return line between the fluid outlet 14 in the supply housing 50 and the branch point 54 into which the outlet side of the machining equipment BM emerges. Furthermore, a third V3 and a fourth switching valve V4 is in each case connected to the supply line to the fluid inlet 12 and to the return line from the fluid outlet 14, said switching valves serving to supply or respectively remove a flushing medium DL into/from a further storage tank CM2.

A control line 56, which serves to transmit measurement data and allows a flushing operation to take place according to the status of the machine and/or measuring apparatus, runs between the machining equipment BM and the measuring apparatus, the housing of which is reproduced in FIG. 10 with housing parts 20, 42 and 50. Measurement parameter detection, which is at least partially performed via the sensor 38, transmits its measurement data via an additional measurement line 56 to a processor controller 59 as the higher-level system, which is not shown in further detail, as illustrated in FIG. 10. In addition to the usual measurement values of pressure, temperature and viscosity, it is also possible to detect the pH value of the fluid and its electrical conductivity via the sensor 38 or further sensors 1, 2, . . . x, which are not shown. Starting from a further control line 60 according to FIG. 9, the measuring apparatus is able to control a further fluid pump P2, which, if necessary, extracts missing concentrate detected by means of the measuring apparatus from a concentrate vessel CM3, the filling level in the concentrate vessel CM3 being monitored by a level switch 62, which is connected by means of a further measurement line 64 to the processor controller 59 of the measuring apparatus. Accordingly, if, in conjunction with the refractometry performed by means of the measuring apparatus, it is observed that lubricant constituents in connection with the coolant lubricant supply for the machining equipment BM are missing, or HFC in connection with the supply of an HFC hydraulic fluid is missing, the corresponding missing constituents can be added to the storage tank CM1 by actuating the supply pump P2 via the concentrate vessel CM3, and the resulting correctly concentrated cooling lubricant quantity or HFC hydraulic fluid then passes into the machining equipment BM, whereupon a refractometer measurement is accordingly continuously performed by means of the measuring apparatus as part of the concentration process. The adjustment means referred to as external actuator 1, 2, . . . y in FIG. 10 in this case correspond inter alia to components P1 and P2 and to valves V1, V2, V3, V4 etc.

In the event of contamination, especially with regard to the sample chamber 10, the supply circuit 16 can be shut off by means of the valves V1, V2 and by opening the valves V3 and V4 the sample chamber 10 can be flushed by supplying an appropriate flushing medium DL including compressed air and, in this manner, cleaned of particulate contamination, which is then received in the storage tank CM2 for further treatment or disposal. After carrying out the flushing operation, the valves V3 and V4 can then be reset, actuated by spring force, to their original position as shown in FIG. 9, i.e., moved into their closing position, and, after opening the valves V1 and V2 again by switching on the fluid supply circuit 16, the measuring apparatus is then once again available for refractometry measurement.

The measuring apparatus is explained in further detail below with the aid of the associated measurement method. FIG. 2 accordingly shows such a measurement according to the transmitted light principle. In this method, the laser 22 shown in FIG. 1 emits a collimated laser beam 70, which experiences a first refraction n1 at the interface between the sample chamber 10 and the glass wall 28. A second refraction n2 then takes place at the glass wall 28 in the form of a standard glass pane. FIG. 2 describes the change in signal of the line array or sensor surface 46 respectively with different liquid concentrations. If a vertical adjustment takes place in which the vertical distance between the sensor surface 46 and the glass wall 28 is modified, this makes it possible to adjust the sensitivity. The measured value range can be adjusted by a possible horizontal displacement of the sensor surface 46. In the outline representation of the measured value detection process with the illustrated curve characteristic shown in FIG. 2, a homogeneous fluid is analysed in the sample chamber 10; however, it is also possible to inspect cloudy fluids. In principle, this is possible as the laser diode or the laser 22 respectively can be controlled with variable intensity by means of an open and/or closed-loop control device, which is not shown in greater detail, in the form of the processor control 59. For example, however, the laser 22 controls the intensity independently.

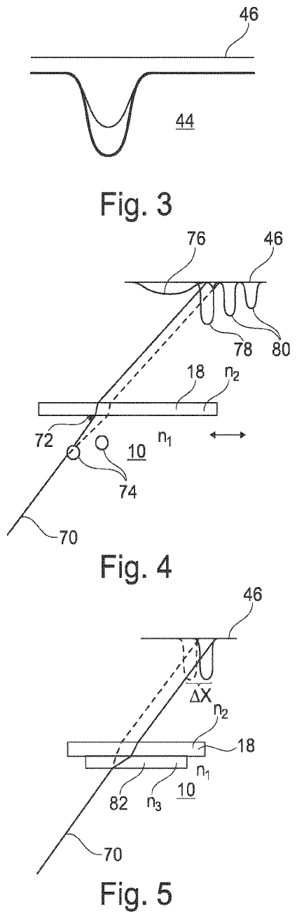

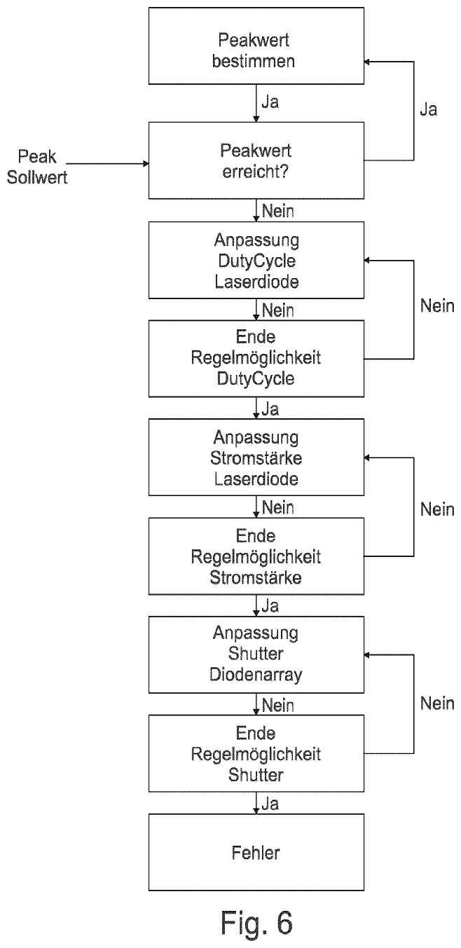

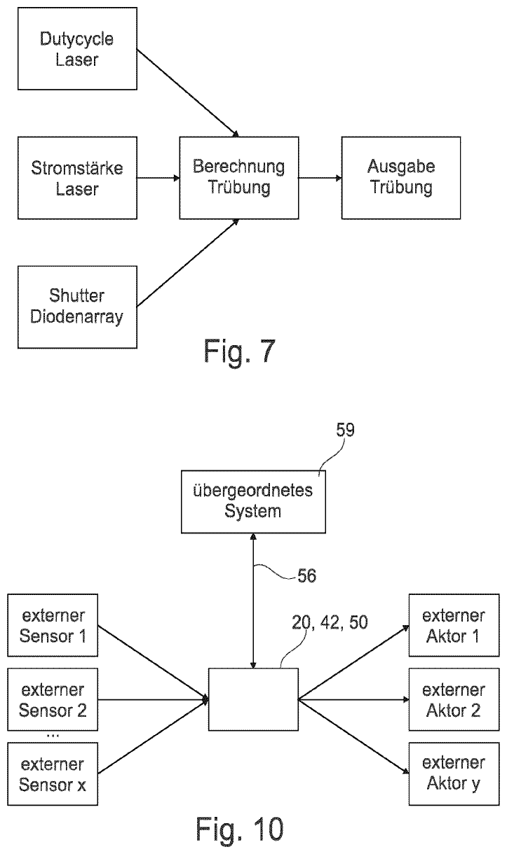

This kind of measured value curve caused by cloudiness of the fluid in the sample chamber 10 is reproduced by way of example in FIG. 3, the measured value curve shown in bold illustrating the original measured value curve and the non-bold measurement line relating to the loss of intensity due to cloudiness of the fluid. In order to return to the previous peak value recording once again despite the loss of intensity, as shown by the bold curve in FIG. 3, an adjustment of the laser 22 is required, for example by adjusting the power cycle of duty cycle, or even by increasing the current intensity for the laser diode. A further adjustment option entails changing the frame rate or image refresh rate respectively, also referred to in technical jargon as shutter frequency, on the photodiode array or diode array in the form of the sensor device 26. A corresponding adjustment of the laser intensity or detector sensitivity respectively with regard to the occurrence of potential cloudiness of the fluid in the sample chamber 10 is reproduced by way of example in the flowchart shown on FIG. 6. In order to carry out the corresponding adjustment cycle, it is in any event a prerequisite that a peak value determination should be carried out as a reference, i.e., specifying a peak value for the light received by refraction on the diode array in the form of the sensor device 26 using a fluid to be analysed homogeneously in the sample chamber 10 as shown in FIG. 2. The actual cloudiness calculation incorporating output values is achieved as shown in FIG. 7 by recording measurement variables with regard to the duty cycle and the current intensity for the laser 20 including calculating the shutter frequency of the diode array of the sensor device 26. In this manner, the disturbance variables arising due to cloudiness can be compensated as part of the standard measurement.

In addition to the aforementioned cloudiness, as shown in FIG. 4, contamination may also arise in the fluid in the sample chamber 10 as a further potential disturbance variable, for example in the form of finely dispersed particles 72, such as those that may regularly arise in emulsions or in the form of larger particles 74 including air bubbles in the volume flow moved inside the sample chamber 10. In this case, the measured value curve that results from a broad increase in intensity due to laser scattering as caused by the finely dispersed particles 72 in the fluid flow is shown to the far right of FIG. 4, based on an average peak value 78 with a rounded measurement value curve as obtained during the usual refraction by fluid n1 and glass pane n2. The short-term sharp peaks with variable intensity that arise from a different refraction caused by the aforementioned particles 74 or the incorporation of air bubbles are significantly different from the above. The corresponding disturbance variables can also be compensated as they are detected individually and do not disrupt the concentrate determination of the fluid used with the measuring apparatus.

The drawing in FIG. 5 in turn relates to a different disturbance variable in connection with the concentration measurement, in which a translucent, surface contamination with a different refraction value n3 arises on the glass wall 18 with its refraction value of n2. Accordingly, FIG. 5 shows the peak curve on the sensor surface 46 (diode array) as a dashed line, without contamination 82 and the right-hand curve shows the evaluation with the contamination applied to the glass pane 18. Accordingly, the two peak curves shown in FIG. 5 with the same measured value levels, viewed in the horizontal direction, are displaced by a value of Δx, which can be evaluated and thus permits conclusions as to the level of contamination 42 on the glass pane 18. As such, this disturbance variable can then also be calculated again when determining the fluid concentrate.

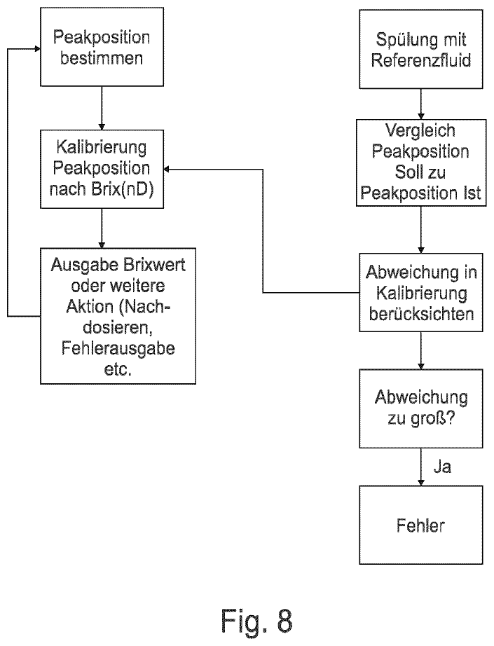

In the case of all the aforementioned disturbance variables, such as fluid cloudiness, particulate contamination or impurities on the glass wall 18, as described above for FIG. 9, a flushing operation can be performed for the sample chamber 10, the associated procedure being reproduced in outline in FIG. 8. In this case, a measurement and flushing process can basically take place as follows:
OPEN=Supply the measuring apparatus by opening valves V1 and V2
MEAS=Measurement 1 is performed for a defined period (fluid=cooling lubricant or HFC)
CLOSE=Stop the flow to the measuring apparatus by closing valve V1 and valve V2
FL1=Start flushing operation by opening valves V3 and V4
FLU=Flush the sample chamber 10 for a defined period
FL2=End the flushing operation, valves V3 and V4 remain open
CAL=Measurement 2 is performed for a defined period (fluid=flushing fluid, water or through air)
EVAL=Evaluation of measurement 2 from CAL and reporting (measurement OK, recalibration, servicing required)
FL3=Close valves V3 and V4

The refractometer described above to measure the concentration of the concentrate of a cooling lubricant or an HFC liquid or other fluids where the concentration of constituents needs to be monitored, carries out individual discrete measurements, during which the index of refraction to determine the concentration of cooling lubricant lies between 0 and 25% Brix (value of the index of refraction) and that of HFC lies between 30 and 50% Brix. As part of self-diagnostics, it is possible to carry out a regular internal check on the sensor device 26 to determine the validity of the measurement data. If, for example, no peak values (hotspots) can be detected on the diode array or sensor surface 46 respectively due to excessive cloudiness in the fluid, the sensor device 26 should not issue any further measured values and this should be displayed by the status of the sensor device 26.

Furthermore, what is known as an in-line calibration can be carried out using the measuring apparatus. After flushing the sample chamber 10 or measurement cell respectively, a reference measurement is performed in water or air respectively. If a deviation from the expected value of the flushing fluid is measured, the sensor device 26 is automatically recalibrated. To this end, the measured value with flushing fluid is used as the new zero value. Furthermore, a ‘Clean refractometer’ or similar warning is issued. By evaluating the deviation from the original value when starting up, it is also possible to predict when the laser 22 and/or the glass wall 18 will need to be exchanged based on damage to the glass pane in accordance with the examples of embodiments shown on FIG. 2 to 5. This therefore has no parallel in the prior art.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for determining the concentration of constituents in a fluid, such as cooling lubricants or HFC fluids, using refractometry using a laser of a measuring device that uses the transmitted light principle, comprising at least:
specifying a peak value for the laser light received by refraction on a diode array using a homogeneous fluid to be transilluminated; and
keeping the peak value constant despite the occurrence of disturbances by adapting one or more of:
the duty cycle of the laser,
the current intensity for the laser, and
the sensitivity of the diode array using an evaluation circuit.

12. The method of claim 11, wherein the disturbance variable may be formed by cloudiness of the fluid, as a result of which a loss in intensity of the peak value of the laser light received on the diode array arises.

13. The method of claim 11, wherein the disturbance variable may be formed by a finely dispersed particulate contamination, as a result of which a broad increase in intensity arises due to laser scattering on the diode array.

14. The method of claim 11, wherein the disruption variable is formed by larger particles or air bubbles which are entrained in the fluid to be measured along with said fluid and lead to a short-term occurrence of measured value peaks on the diode array, the measured value thereof being smaller than the peak value measured during refraction by a homogeneous fluid.

15. The method of claim 11, wherein the disruption variable is formed by contamination on a laser-translucent wall of a sample chamber, along which the fluid is passed, through both of which the laser light is passed, and wherein the contamination is detected by the diode array by a path displacement with respect to the set peak value during the usual refraction process.

16. The method of claim 11, wherein, for a measurement operation with the measuring device, said device is calibrated using a reference fluid to a pre-definable value of the index of refraction (Brix).

17. The method of claim 11, wherein during a flushing operation of the measuring device, flushing of a sample chamber takes place with the reference fluid, wherein a comparison takes place between the actual value and the target value of the respective index of refraction (Brix), and wherein a potential deviation is taken into consideration in the calibration and an error message is output if the deviation is excessive.

18. The method of claim 11, wherein the measuring device is monitored by the higher-level evaluation circuit, which evaluates measurement data from one or more additional, externally connected measurement devices, and wherein, as a function of the measurement data received, one or more external actuators are actuated.

19. The method of claim 11, wherein the measuring device is connected in a secondary branch of a hydraulic supply circuit which supplies a hydraulic load with fluid, said measuring device being connected to or disconnected from the supply circuit using a valve controller.

20. The method of claim 11, wherein the fluid is admitted to the fluidic supply circuit using a supply device if there is insufficient concentrate in the fluid.

21. The method of claim 12, wherein the disturbance variable may be formed by a finely dispersed particulate contamination, as a result of which a broad increase in intensity arises due to laser scattering on the diode array.

22. The method of claim 12, wherein the disruption variable is formed by larger particles or air bubbles which are entrained in the fluid to be measured along with said fluid and lead to a short-term occurrence of measured value peaks on the diode array, the measured value thereof being smaller than the peak value measured during refraction by a homogeneous fluid.

23. The method of claim 13, wherein the disruption variable is formed by larger particles or air bubbles which are entrained in the fluid to be measured along with said fluid and lead to a short-term occurrence of measured value peaks on the diode array, the measured value thereof being smaller than the peak value measured during refraction by a homogeneous fluid.

24. The method of claim 12, wherein the disruption variable is formed by contamination on a laser-translucent wall of a sample chamber, along which the fluid is passed, through both of which the laser light is passed, and wherein the contamination is detected by the diode array by a path displacement with respect to the set peak value during the usual refraction process.

25. The method of claim 13, wherein the disruption variable is formed by contamination on a laser-translucent wall of a sample chamber, along which the fluid is passed, through both of which the laser light is passed, and wherein the contamination is detected by the diode array by a path displacement with respect to the set peak value during the usual refraction process.

26. The method of claim 14, wherein the disruption variable is formed by contamination on a laser-translucent wall of a sample chamber, along which the fluid is passed, through both of which the laser light is passed, and wherein the contamination is detected by the diode array by a path displacement with respect to the set peak value during the usual refraction process.

27. The method of claim 12, wherein, for a measurement operation with the measuring device, said device is calibrated using a reference fluid to a pre-definable value of the index of refraction (Brix).

28. The method of claim 13, wherein, for a measurement operation with the measuring device, said device is calibrated using a reference fluid to a pre-definable value of the index of refraction (Brix).

29. The method of claim 18, wherein the measurement data from the one or more additional, externally connected measurement devices comprises one or more of temperature, pressure, viscosity, electrical conductivity, and pH value.

30. The method of claim 18, wherein the one or more external actuators comprise one or more of hydraulic pumps, valves, and level switches.
